(19) United States
(12) Patent Application Publication
(10) Pub. No.: US 2025/0334143 A1
(43) Pub. Date: Oct. 30, 2025

(54) Anti-Rotation Torque Limiter

(71) Applicant: Illinois Tool Works Inc., Glenview, IL (US)

(72) Inventors: Janeth Lideya Guerrero Arellano, Estado de Mexico (MX); Sean M. O’Reilly, Lexington, KY (US); Thomas A. Benoit, Bourbonnais, IL (US)

(21) Appl. No.: 19/179,624

(22) Filed: Apr. 15, 2025

Related U.S. Application Data
(60) Provisional application No. 63/638,566, filed on Apr. 25, 2024.

(51) Int. Cl. F16B 39/24

(52) U.S. Cl. CPC F16B 39/24

(57) ABSTRACT

Described is a retainer assembly for securing a first component relative to a second component using a fastener. The retainer assembly includes a modular clip with a cylindrical body featuring a through hole for the fastener shank and an arm. A base component with a retainer secures the first component and contains a limiter aperture to accommodate the cylindrical body. Additionally, multiple alignment apertures are arranged around the limiter aperture, each corresponding to a specific orientation and to receive a portion of the arm for secure positioning.

### RELATED APPLICATION

The present application claims priority to U.S. Provisional Patent Application No. 63/638,566, filed Apr. 25, 2024, and entitled “Anti-Rotation Torque Limiter,” which is hereby incorporated by reference in its entirety.

### BACKGROUND

Vehicular (e.g., automotive) components require attachment and fastening techniques that are simple to manufacture and assemble while ensuring reliable and secure connections. Traditional fastening techniques, such as threaded fasteners and/or clips, often suffer from several drawbacks, including difficulties in maintaining proper alignment during installation, unintended rotation of the retainer assembly when torque is applied, and the potential for damage to the components being fastened. Specifically, excessive torque applied during installation can lead to crushing or deformation of structural components, compromising the integrity and longevity of the assembly. Additionally, conventional fastening methods may not accommodate variations in component configurations, limiting their versatility across different applications.

Therefore, despite advancements to date, there exists a need for a retainer assembly that addresses these challenges by incorporating a removable insert component configured to enhance engagement with a corresponding component. For example, preventing rotation of the base structure relative to the component during the fastening process, thereby ensuring a secure and stable connection and preventing structural damage due to excessive torque while maintaining the integrity of the assembly.

### SUMMARY

The present disclosure relates generally to a fastening system to form a connection between two components, such as vehicular components and other objects, substantially as illustrated by and described in connection with at least one of the figures, as set forth more completely in the claims. In an example, the present disclosure provides a retainer assembly having a removable insert component that provides improved engagement with the component to which it is mounted, prevents rotation, and offers compression protection.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a fastening system in an open position and configured to secure one or more first components relative to a second component having one or more openings formed therein via a retainer assembly in accordance with an aspect of this disclosure.

FIG. 1b illustrates the fastening system of FIG. 1a in an assembled, closed position.

FIGS. 2a and 2b illustrate, respectively, isometric, and top plan views of the retainer assembly of FIGS. 1a and 1b.

FIGS. 2c and 2d illustrate, respectively, cross-sectional isometric and side elevation views of the retainer assembly in the open position taken along cut line A-A (FIG. 2a).

FIGS. 3a and 3b illustrate, respectively, first and second isometric views of the modular clip of the retainer assembly.

FIGS. 3c and 3d illustrate, respectively, top, and bottom plan views of the modular clip.

FIGS. 3e through 3h illustrate, respectively, first, second, third, and fourth side elevation views of the modular clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a retainer assembly having a removable insert component that provides improved engagement with the component to which it is mounted, prevents rotation, and offers compression protection.

In one example, a retainer assembly for securing a first component relative to a second component via a fastener comprises: a modular clip having a cylindrical body and an arm extending away from the cylindrical body, wherein the cylindrical body defines a through hole configured to receive a shank of the fastener; and a base component having a retainer configured to secure the first component, wherein the base component comprises a limiter aperture configured to receive the cylindrical body and a plurality of alignment apertures positioned axially around the limiter aperture, and wherein each of the plurality of alignment apertures is associated with one of a plurality of orientations and is configured to receive a portion of the arm. The cylindrical body can have a height that is substantially equal to the thickness of the base component at or adjacent to the limiter aperture.

In another example, a modular clip for mitigating rotation of a retainer assembly relative to a component and limiting torque upon the retainer assembly comprises: a cylindrical body having a through hole that is configured to receive a shank of a threaded fastener; one or more projections formed on an exterior sidewall of the cylindrical body; and an arm coupled to an end of the cylindrical body that extends away from the cylindrical body, wherein the arm comprises a first linear portion coupled to the cylindrical body and a second linear portion that is coupled to the first linear portion at a 90-degree angle such that the second linear portion is parallel to the exterior sidewall of the cylindrical body, and wherein the cylindrical body has a height that is less than a height of the second linear portion. The cylindrical body, the one or more projections, and the arm can be a unitary plastic structure.

In yet another example, a retainer assembly for securing a first component relative to a second component via a fastener comprises: a base component; and a modular clip having a cylindrical body and an arm extending away from the cylindrical body, wherein the modular clip is configured to couple with the base component in one of a plurality of orientations and to engage the second component through the base component via the arm.

In some examples, the base component comprises a limiter aperture configured to receive the cylindrical body, and a plurality of alignment apertures positioned axially around the limiter aperture.

In some examples, each of the plurality of alignment apertures is configured to receive a portion of the arm.

In some examples, each of the plurality of alignment apertures corresponds to one of the plurality of orientations.

In some examples, the limiter aperture has a cross-sectional shape that is circular.

In some examples, each of the plurality of alignment apertures has a cross-sectional shape that is rectangular.

In some examples, the modular clip comprises one or more projections formed on an exterior sidewall of the cylindrical body to facilitate a friction fit with the base component.

In some examples, the modular clip comprises three projections formed on an exterior sidewall of the cylindrical body.

In some examples, the modular clip comprises an annular collar formed at an end of the cylindrical body.

In some examples, the arm is coupled at an end of the cylindrical body.

In some examples, the arm comprises a first linear portion and a second linear portion arranged at an angle relative to one another.

In some examples, the angle is about 90 degrees.

In some examples, the second linear portion is substantially parallel to an exterior sidewall of the cylindrical body.

In some examples, the cylindrical body defines a through hole configured to receive a shank of the fastener.

In some examples, the retainer assembly further comprises a retainer configured to secure the first component, wherein the retainer and the base component are a unitary structure.

In some examples, the retainer comprises a carrier body and a lid coupled to the carrier body via a hinge.

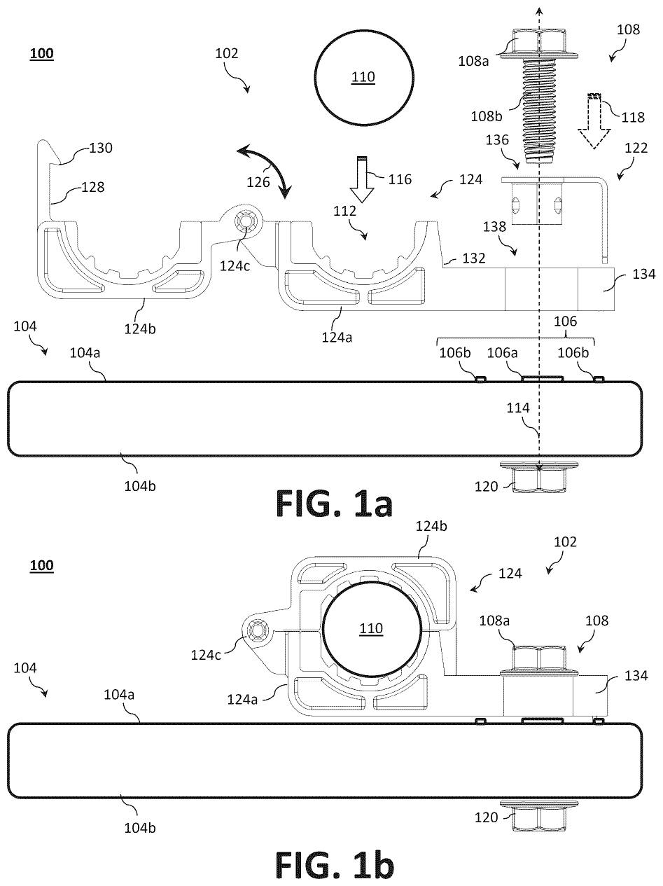

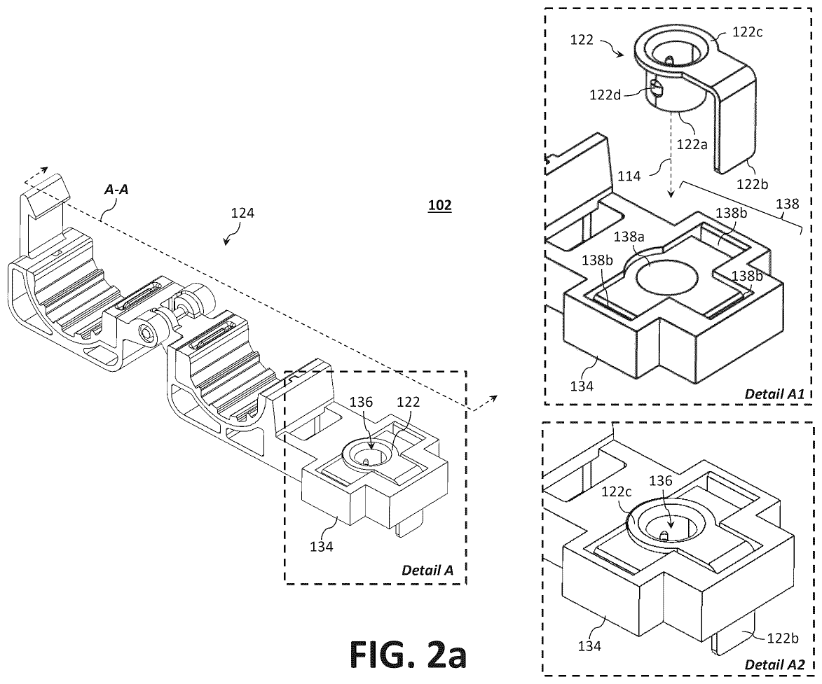

FIGS. 1a and 1b illustrate a fastening system 100 configured to secure one or more first components 110 relative to a second component 104. The fastening system 100 is illustrated in an open, assembly position (FIG. 1a) and in a closed, assembled position (FIG. 1b). The one or more first components 110 are illustrated as one or more tubes, which may be, for example, brake lines, fuel lines, wires, cables (e.g., electric cables), pipes, or any other tubular structure that may be secured to a second component 104. While the retainer assembly 102 will be described primarily as an assembly configured to attach tubes, the teachings of the subject disclosure can be used to attach a plethora of other objects and components relative to the second component 104 where providing anti-rotation and torque protection is desired.

In the illustrated example, the fastening system 100 is configured to join the first component 110 to the second component 104 and generally comprises, a retainer assembly 102, a male fastener 108, and a female fastener 120. As illustrated, the first component 110 is coupled to the retainer assembly 102 and the retainer assembly 102 is coupled to the second component 104 via the male fastener 108 and the female fastener 120. In some examples, a pair of wings can be positioned at or near a junction between the retainer assembly 102 and the second component 104 to mitigate wobble and/or buzz, squeak, and rattle (BSR), which can be caused by unintended contact or vibration between the retainer assembly 102 and the second component 104.

The second component 104 may include, define, or otherwise provide one or more openings 106, which may be formed during manufacturing of the second component 104. The one or more openings 106 can include, inter alia, a fastener opening 106a (e.g., a round hole) and one or more alignment openings 106b (e.g., rectangular slots). The fastener opening 106a is configured to receive the shank 108b of the male fastener 108, while each of the alignment openings 106b is configured to receive a portion of a modular clip 122. In some examples, the retainer assembly 102 may comprise a seal to mitigate dust, dirt, and/or moisture penetration through openings 106 formed in the second component 104. The seal may be embodied as a ring (e.g., an annulus) and fabricated from foam material, thermoplastic, rubber, etc.

The second component 104 defines an A-side surface 104a (e.g., a first surface, such as an exterior surface) and a B-side surface 104b (e.g., a second surface, such as an interior surface). During assembly, the male fastener 108 is configured to pass through the retainer assembly 102 (or a portion thereof) positioned on the A-side surface 104a, and through the second component 104 to engage and secure with the female component 120 positioned on the B-side surface 104b. The first component 110 is illustrated as being secured to or on the A-side surface 104a of the second component 104 via the retainer assembly 102.

The second component 104 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the second component 104 may be fabricated from metal (or a metal alloy), synthetic or semi-synthetic polymers (e.g., plastics, such as acrylonitrile butadiene styrene (ABS) and polyvinyl chloride (PVC), etc.), composite materials (e.g., fiberglass), or a combination thereof.

The illustrated male fastener 108 generally comprises a head 108a and a shank 108b, which, in this example, is a hex head with a threaded shank (e.g., a bolt). The female fastener 120 (e.g., a nut) comprises a threaded opening configured to threadedly engage the shank 108b. During assembly, the male fastener 108 is rotated relative to the female fastener 120 about its axis of rotation 114 to threadedly engage the female fastener 120. As the male fastener 108 is rotated and torqued, the retainer assembly 102 is compressed and, therefore, secured, between the head 108a and the second component 104. In the illustrated example, it is contemplated that the male fastener 108 and the female fastener 120 are fabricated from metal, but other materials are possible, such as plastic materials. Further, while a threaded male fastener 108 and a threaded female fastener 120 are shown and described, other fastener arrangements are contemplated, such as snap fasteners (push rivets), pins, etc.

The retainer assembly 102 generally comprises the modular clip 122 and a retainer 124 having a base component 134. The modular clip 122 serves as an anti-rotation torque limiter that mitigates rotation and damage from torque. The modular clip 122 includes a cylindrical body 122a and an arm 122b extending away from the cylindrical body 122a. While the cylindrical body 122a is illustrated as cylindrical, other shapes are contemplated, such as cubes and rectangular prisms.

The retainer 124 is configured to couple with and/or secure one or more first components 110 relative to one another and, ultimately, to the second component 104 via the base component 134. While the retainer 124 and the base component 134 are illustrated as a single, integrated component (e.g., a unitary structure), they could alternatively be configured as separate components that are coupled or adhered to one another (e.g., via adhesives, welding, a mechanical coupling, or the like).

The retainer 124 is illustrated with a single pocket 112 that is configured to secure a first component 110. The illustrated retainer 124 includes a carrier body 124a and a lid 124b to secure the one or more first components 110 within the pocket 112. The lid 124b is configured to pivot relative to the carrier body 124a via a hinge 124c about a hinge axis between an open position (FIG. 1a) and the closed position (FIG. 1b) as indicated by arrow 126 to provide access to one or more of the plurality of pockets 112 during installation of the one or more first components 110 (or other objects). The hinge 124c can use a pin as illustrated or, in other examples, can be a living hinge. When in an open position, a first component 110 can be inserted into the pocket 112 by urging the first component 110 toward the pocket 112 in the direction indicated by arrow 116. Once the first component 110 is inserted, the lid 124b can be pivoted about the hinge 124c to the closed position. In lieu of the lid 124b, one or more of the plurality of pockets 112 may be shaped to secure the one or more first components 110 via an interference fit (e.g., via features positioned at the opening to the plurality of pockets 112, such as a ledge, bumps, etc.).

A snap 128 is provided at the free end of the lid 124b (e.g., opposite the hinge 124c) that is configured to engage, via a hook 130, a corresponding feature 132 formed in or on the carrier body 124a of the retainer 124, such as a recess, opening, or otherwise having a ledge, edge, or other protrusion. In some examples, one or more of the snaps 128 may include a button or tab that a user can manipulate to release the snap 128 from its corresponding feature 132 to open the lid 124b and remove a first component 110. The button or tab is designed to disengage the snap 128 from its corresponding features 132 to open the lid 124b.

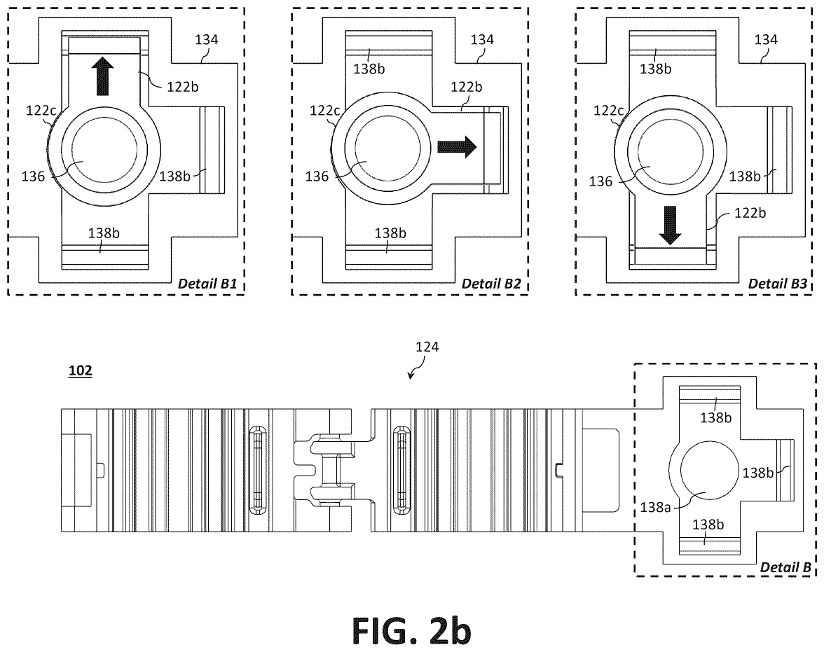

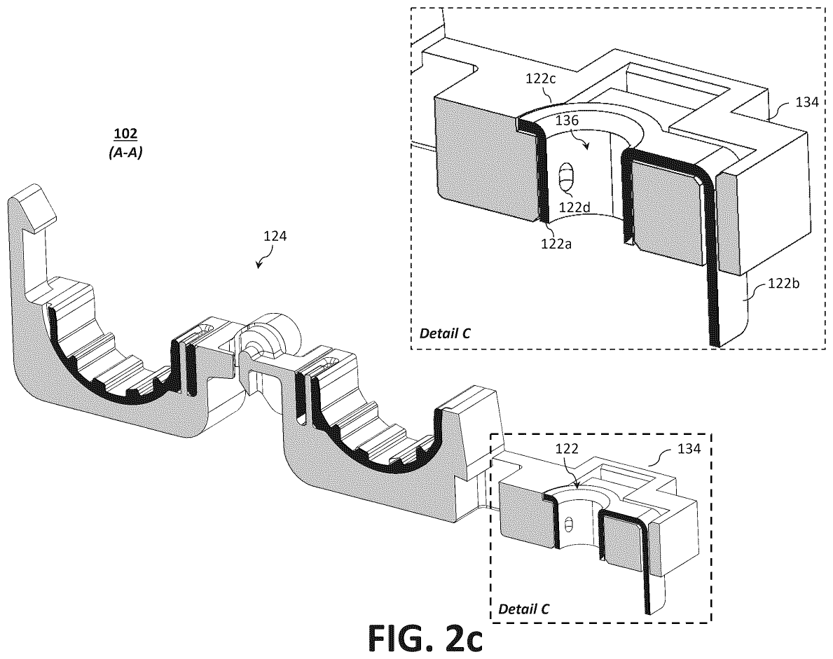

As will be described in connection with FIGS. 2a and 2b, the modular clip 122 is configured to be coupled to the base component 134 in one of a plurality of orientations, which allows the retainer assembly 102 to be rotationally fixed in a desired orientation. FIGS. 2a and 2b illustrate, respectively, isometric, and top plan views of the retainer assembly 102 of FIGS. 1a and 1b. FIGS. 2c and 2d illustrate, respectively, cross-sectional isometric and side elevation views of the retainer assembly 102 in the open position taken along cut line A-A (FIG. 2a).

With reference to FIG. 2a, the base component 134 may include, define, or otherwise provide one or more retainer apertures 138 configured to receive and/or retain the modular clip 122. The one or more retainer apertures 138 can include, inter alia, a limiter aperture 138a and one or more alignment apertures 138b. The one or more retainer apertures 138 can be formed during manufacturing of the base component 134 (e.g., during a molding process). When assembled, the limiter aperture 138a is generally concentric with the threaded fastener shank 108b and a through hole 136 formed through the cylindrical body 122a.

The limiter aperture 138a is sized and shaped to receive the cylindrical body 122a. To that end, the inner diameter of the limiter aperture 138a may be substantially similar to the outer diameter of the cylindrical body 122a. In this example, the limiter aperture 138a has a circular cross section (defining a cylindrical passageway). While each of the limiter aperture 138a and the cylindrical body 122a is illustrated as having a circular cross section, other shapes are contemplated, including cross sections that are quadrilateral or polygonal (e.g., pentagonal, hexagonal, heptagonal, octagonal, nonagonal, decagonal, dodecagon, etc.). Similarly, each of the alignment apertures 138b is sized and shaped to receive the arm 122b. To that end, the inner perimeter of the alignment apertures 138b may be substantially similar to the outer perimeter of the arm 122b. In this example, the alignment apertures 138b has a rectangular cross section (defining a passageway shaped as a rectangular prism).

During installation, the base component 134 of the retainer assembly 102 is aligned with the openings 106 formed in or on a surface of the second component 104, as indicated by arrow 118, such that the male fastener 108 can pass through the base component 134 and the fastener opening 106a.

With reference to FIG. 2a at Details A1 and A2, the cylindrical body 122a of the modular clip 122 is aligned with the limiter aperture 138a of the base component 134 with the arm 122b aligned such that the arm 122b can be inserted into a desired one of the one or more alignment apertures 138b. As illustrated, wherein the base component 134 comprises a limiter aperture 138a configured to receive the cylindrical body 122a and three alignment apertures 138b positioned axially around the limiter aperture 138a. Detail A1 illustrates an assembly view of the modular clip 122 aligned with the base component 134, while Detail A2 illustrates the modular clip 122 assembled with the base component 134 and oriented at the 3 o'clock orientation. As illustrated, the arm 122b passes through the base component 134 to engage an alignment opening 106b, thus rotationally fixing the base component 134 relative to the second component 104.

As best illustrated in FIG. 2b at Details B1, B2, B3 (as indicated by the arrow), the one or more alignment apertures 138b are associated with the 12 o'clock, 3 o'clock, and 9 o'clock orientations, though other orientations are contemplated depending on the design needs. The existence of plural (e.g., three in this example) separate alignment apertures 138b for the arm 122b of the modular clip 122 clip allows for modularity in that one base component 134 can be made and used with three different applications rather than necessitating three separate components.

With reference to FIGS. 2c and 2d, in addition to preventing or mitigated unwanted rotation, the modular clip 122 prevents the base component 134 from being crushed when the male fastener 108 is torqued down. For example, the height (H₁) of the cylindrical body 122a can be substantially the same as the height (H₂) (e.g., thickness) of the base component 134. Thus, the illustrated cylindrical body 122a has a height (H₁) that is substantially equal to a height (H₂) (e.g., thickness) of the base component 134 at or adjacent to the limiter aperture 138a.

As illustrated in FIGS. 2a (Detail A2), 2c (Detail C), and 2d (Detail D), the second linear portion 122b2 extends beyond the cylindrical body 122a such that is passes through the base component 134 to engage (e.g., being inserted into) an alignment opening 106b formed in the second component 104. The cylindrical body 122a has a height (H₁) that is less than a height (H₃) of the second linear portion 122b2. As illustrated, the second linear portion 122b2 has a height (H₃) that is substantially greater than the height (H₁) of the cylindrical body 122a and the height (H₂) (e.g., thickness) of the base component 134 to allow the second linear portion 122b2 to engage the alignment opening 106b.

As a result, the cylindrical body 122a would absorb the compressive force from the male fastener 108, thus reducing strain on the base component 134. As best illustrated in FIG. 2d, a perimeter of the limiter aperture 138a and the area between the limiter aperture 138a and the alignment aperture(s) 138b can also be beveled, chamfered, or countersunk at the top side to account for the thickness of the annular collar 122c and the arm 122b to thereby allow for the annular collar 122c and upper portion of the arm 122b to be recessed.

The retainer assembly 102, or portions thereof, can be fabricated via mold tooling and a plastic-injection molding process. In some examples, components of the retainer assembly 102 can be fabricated from dissimilar materials. For example, the retainer 124 and the base component 134 may be fabricated from a plastic material, while the modular clip 122 could be fabricated from metal.

In another example, the retainer assembly 102, or portions thereof, can be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the retainer assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (um). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., the higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the retainer assembly 102 may be formed or otherwise fabricated at different resolutions during a printing operation. For example, the retainer 124 (or portions thereof) may be printed at a lower resolution than that of the base component 134 or vice versa as needed for a particular application.

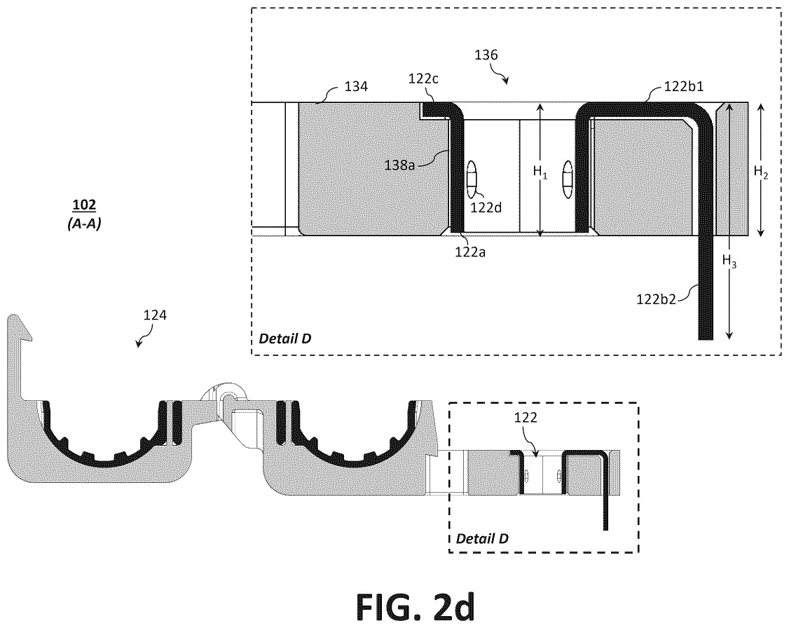

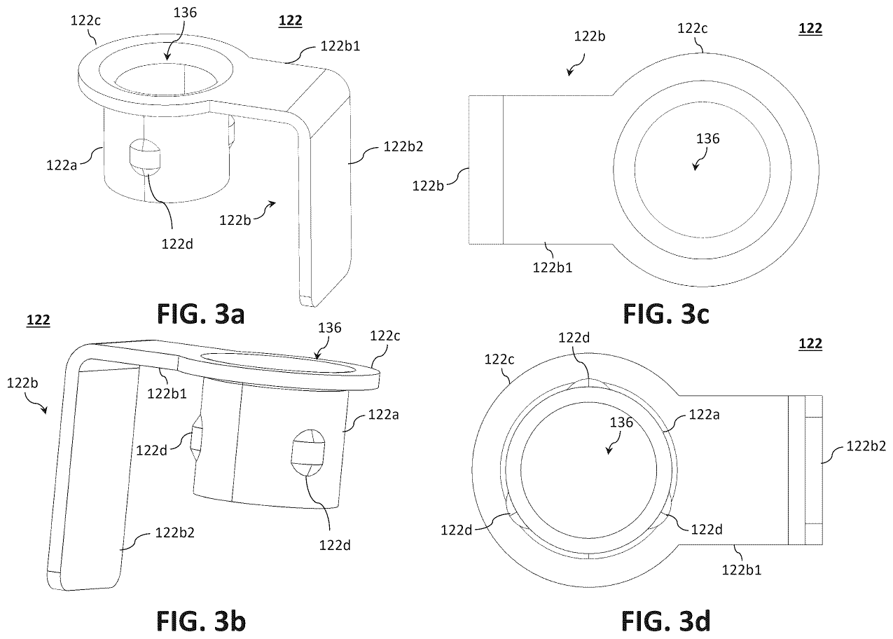

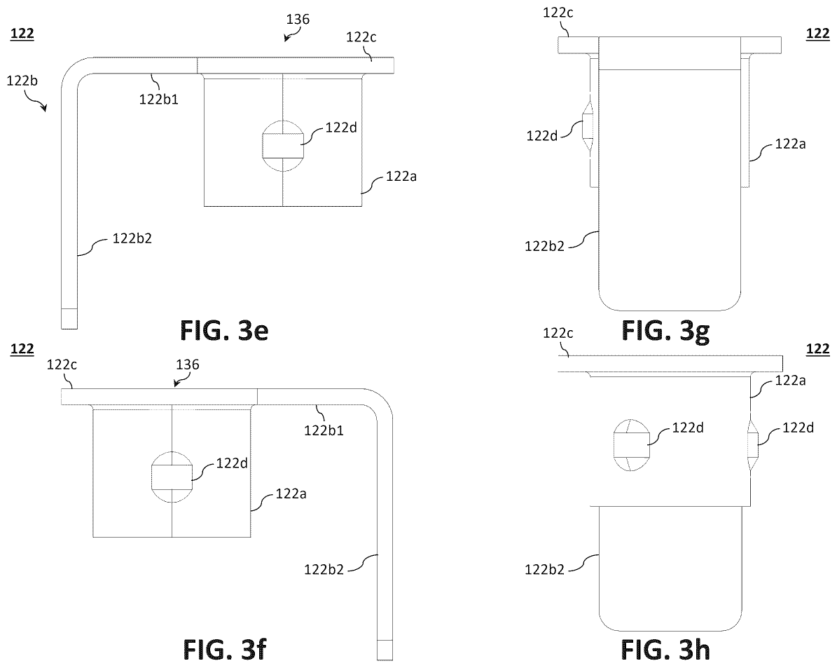

FIGS. 3a and 3b illustrate, respectively, first and second isometric views of the modular clip 122 of the retainer assembly 102, while FIGS. 3c and 3d illustrate, respectively, top, and bottom plan views of the modular clip 122. Finally, FIGS. 3e through 3h illustrate, respectively, first, second, third, and fourth side elevation views of the modular clip 122.

In the illustrated example, the modular clip 122 is configured as a modular component that can be installed within the base component 134 in one of multiple different orientations. The modular clip 122 includes a cylindrical body 122a and an arm 122b extending away from the cylindrical body 122a. In the illustrated example, the cylindrical body 122a includes or otherwise defines an annular collar 122c at an end (e.g., the upper end where the arm 122b is attached). The annular collar 122c serves to provide stability to the modular clip 122 when installed (e.g., to prevent the cylindrical body 122a from penetrating too deeply into the base component 134 and to mitigate side-to-side motion). The modular clip 122 can be formed from plastic (e.g., via molding process, additive manufacturing, etc.) or, where desired, metal (e.g., via a stamping/extruding process). One or more projections 122d formed on the cylindrical body 122a assist in retaining the clip within the limiter aperture 138a. The one or more projections 122d serve to create or otherwise facilitate a friction fit with an interior sidewall of the limiter aperture 138a. The one or more projections 122d are illustrated as three protuberances (or bumps) formed on an exterior sidewall of the cylindrical body 122a. While three evenly distributed projections 122d are illustrated, additional or fewer projections 122d can be employed. Further, while protuberances are illustrated, other techniques could be used to retain the clip within the component (e.g., ribs, snaps, adhesive, etc.).

The arm 122b can be shaped with a first linear portion 122b1 and a second linear portion 122b2 arranged to define a 90-degree angle. The first linear portion 122b1 is co-planar with the annular collar 122c and the second linear portion 122b2 is positioned 90 degrees relative to the first linear portion 122b1. In this example, the second linear portion 122b2 is parallel to the cylindrical body 122a.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A retainer assembly for securing a first component relative to a second component via a fastener, the retainer assembly comprising:
a modular clip having a cylindrical body and an arm extending away from the cylindrical body,
wherein the cylindrical body defines a through hole configured to receive a shank of the fastener; and
a base component having a retainer configured to secure the first component,
wherein the base component comprises a limiter aperture configured to receive the cylindrical body, and a plurality of alignment apertures positioned axially around the limiter aperture, and
wherein each of the plurality of alignment apertures is associated with one of a plurality of orientations and is configured to receive a portion of the arm.

2. The retainer assembly of claim 1, wherein the cylindrical body has a height that is substantially equal to a thickness of the base component at or adjacent to the limiter aperture.

3. A retainer assembly for securing a first component relative to a second component via a fastener, the retainer assembly comprising:
a base component; and
a modular clip having a cylindrical body and an arm extending away from the cylindrical body,
wherein the modular clip is configured to couple with the base component in one of a plurality of orientations and to engage the second component through the base component via the arm.

4. The retainer assembly of claim 3, wherein the base component comprises a limiter aperture configured to receive the cylindrical body, and a plurality of alignment apertures positioned axially around the limiter aperture.

5. The retainer assembly of claim 4, wherein each of the plurality of alignment apertures is configured to receive a portion of the arm.

6. The retainer assembly of claim 4, wherein each of the plurality of alignment apertures corresponds to one of the plurality of orientations.

7. The retainer assembly of claim 4, wherein the limiter aperture has a cross-sectional shape that is circular.

8. The retainer assembly of claim 4, wherein each of the plurality of alignment apertures has a cross-sectional shape that is rectangular.

9. The retainer assembly of claim 3, wherein the modular clip comprises one or more projections formed on an exterior sidewall of the cylindrical body to facilitate a friction fit with the base component.

10. The retainer assembly of claim 3, wherein the modular clip comprises three projections formed on an exterior sidewall of the cylindrical body.

11. The retainer assembly of claim 3, wherein the modular clip comprises an annular collar formed at an end of the cylindrical body.

12. The retainer assembly of claim 3, wherein the arm is coupled at an end of the cylindrical body.

13. The retainer assembly of claim 12, wherein the arm comprises a first linear portion and a second linear portion arranged at an angle relative to one another.

14. The retainer assembly of claim 13, wherein the angle is about 90 degrees.

15. The retainer assembly of claim 13, wherein the second linear portion is substantially parallel to an exterior sidewall of the cylindrical body.

16. The retainer assembly of claim 13, wherein the cylindrical body defines a through hole configured to receive a shank of the fastener.

17. The retainer assembly of claim 3, further comprising a retainer configured to secure the first component, wherein the retainer and the base component are a unitary structure.

18. The retainer assembly of claim 3, wherein the retainer comprises a carrier body and a lid coupled to the carrier body via a hinge.

19. A modular clip for mitigating rotation of a retainer assembly relative to a component and limiting torque upon the retainer assembly, the modular clip comprising:
a cylindrical body having a through hole that is configured to receive a shank of a threaded fastener;
one or more projections formed on an exterior sidewall of the cylindrical body; and
an arm coupled to an end of the cylindrical body that extends away from the cylindrical body,
wherein the arm comprises a first linear portion coupled to the cylindrical body and a second linear portion that is coupled to the first linear portion at a 90-degree angle such that the second linear portion is parallel to the exterior sidewall of the cylindrical body, and
wherein the cylindrical body has a height that is less than a height of the second linear portion.

20. The modular clip of claim 19, wherein the cylindrical body, the one or more projections, and the arm are a unitary plastic structure.
